(19) United States
(12) Patent Application Publication
(10) Pub. No.: US 2026/0266064 A1
(43) Pub. Date: Sep. 10, 2026

(54) VENETIAN-STYLE FLOORING MADE OF THIN AND LIGHTWEIGHT SLABS, AND THE CORRESPONDING CONSTRUCTION METHOD

(71) Applicant: FELTRACCO FRATELLI SRL, Riese Pio X (IT)

(72) Inventors: Mosè FELTRACCO, Riese Pio X (IT); Ismaele FELTRACCO, Riese Pio X (IT)

(21) Appl. No.: 19/167,401

(22) PCT Filed: Mar. 29, 2024
(86) PCT No.: PCT/IB2024/053098

§ 371 Date: Sep. 22, 2025

(30) Foreign Application Priority Data
Mar. 31, 2023 (IT) 102023000006441

(51) Int. Cl. E04F 15/12

(52) U.S. Cl. CPC E04F 15/126

(57) ABSTRACT

This concerns Venetian-style flooring made of thin and lightweight slabs, and the corresponding construction method.

The object of the present invention relates to Venetian-style flooring made of thin and lightweight slabs and the corresponding construction method.

### PRIOR ART

It is known that one of the most interesting floors of civil dwellings of the past, which remains interesting to this day, is Venetian-style flooring.

It is flooring directly made on the subfloor and consists of a layer of screed, which is made from small pieces of crushed stone, small fragments of marble and other hard stones held together by a cement and/or lime mortar, which is then pressed and polished, revealing the decorative qualities of the stones retained by the mortar.

Such a Venetian-style floor is as beautiful and elegant to admire as it is difficult to make.

In fact, it is a meticulous and challenging job that must be carried out on-site and must also take into account many environmental situations for its overall success.

However, it is not always sturdy and durable, free of cracks, with the correct exposure of the decorative stones.

In fact, there are many things to consider when creating Venetian-style flooring, starting from the subfloor, to the mix of cement and/or lime paste, all the way up to smoothing and the polishing.

Therefore, it is generally acknowledged that the creation of a Venetian-style floor should be carried out by an expert craftsman. Even if it is made by an expert craftsman, there are also many limitations to the possibility of making such a floor, starting from the weight of the product that does not allow it to be installed on a floor that is not structurally strong enough to bear its weight.

Furthermore, this floor cannot be made in certain temperature and humidity conditions, since it has to dry and harden at a certain rate, to prevent unwanted shrinkage and cracking.

Finally, it is not possible to build on a substrate that is not perfectly level, that is not horizontal, or with a limited inclination.

Furthermore, it is not possible to install a Venetian-style floor if the floor or floor slab is prone to bending that exceeds 3% of the height, and finally it is not possible to install a Venetian-style floor if the floor slab cannot support a load greater than 120-150 Kg/sq.m.

A final limitation concerns the thickness of the Venetian-style floor that, even for a minimum thickness of the screed, is always greater than 8 cm.

### OBJECTS OF THE INVENTION

The task proposed by the invention is to eliminate the aforementioned drawbacks in known Venetian-style floors by improving the quality and durability of the object of the invention, allowing them to be installed even in circumstances that were previously not possible with a classic Venetian floor.

Within the scope of the aforementioned task, one purpose proposed by the invention is to create an artefact that overcomes the drawbacks of the prior art.

Another object of the invention is to provide a method of making a Venetian-style floor that has a weight of less than 120-150 Kg/sq.m.

A different object of the invention is to provide a method of making a Venetian-style floor that has a thickness of less than 8 cm.

An important object of the present invention is to provide a method of making a Venetian-style floor that is not restricted by the conditions and limitations of the installation site.

Another object of the invention is to create an artefact in an economically sustainable way, in order to obtain a competitive product.

An appreciable object of the invention is to create an artefact that is completely recyclable and also eco-sustainable.

EXPLANATION OF THE INVENTION

This task as well as these and other objects that will more clearly be explained later are achieved by the lightweight and thin Venetian-style floor slab that is the object of the invention (hereinafter also only: artefact) and a method for making it, according to the invention comprising the technical characteristics according to the appended claims.

Further characteristics and advantages of the invention will become more apparent from the description of a preferred but not exclusive embodiment of the product that includes, on a surface of a slab or panel, the presence of a bottom and a smooth layer on the exposed surface.

In the preferred embodiment the panel's dimensions do not exceed 6.0×4.0 m and, preferably, do not exceed 3.2×1.65 m or 6.0×2.6 m or 3.0×4.0 m and has a thicknesses ranging from 0.8 to 4 cm, and preferably from 1.2 to 3.0 cm to have the benefit of easily being transported from the production site to the installation site and applied to each other seamlessly.

This is a portion of lightweight and thin Venetian-style slab flooring comprising at least one support slab or panel, preferably a honeycomb or alveolar slab, with a thickness of 0.5 to 4 cm and preferably 1.0 to 2.0 cm with a weight of 0.5 to 12 kg/sq. m, an undercoat or primer, directly applied to said slab or panel, with a thickness of 0.1 to 6 mm and preferably 0.2 to 2 mm, a aggregate, placed directly on said undercoat, with a thickness of 0.2 to 4 cm and preferably 0.5 to 2.5 cm comprising:
Pieces of stones, or other material to be exposed on the surface, such as: aggregates or organic materials, or, in particular, cocciopesto, and 30 to 60% marble or stone powders and preferably 40 to 55%, by volume of the dry aggregate, with a maximum size no greater than 1.5 times the thickness of the aggregate with respect to the finished portion of the floor;
Cement from 5 to 20% by volume of the total dry aggregate;
Lime from 10 to 60% by volume of the total dry aggregate;
eventual water-soluble resin powder from 0.5 to 4% by volume of the total dry aggregate (4);
eventual reinforcement fibres for cement made of steel or primarily from polypropylene or synthetic fibres from 0.1 to 8% by volume of the total dry aggregate;
Water with a dispersion of vinyl or acrylic resin, enough to mix the aggregate;
   where the exposed surface of said aggregate is polished, dry polishing using a diamond grinding wheel, in multiple passes, to make the surface flat and shiny, removing any protruding parts and marble dust.

Advantageously said exposed surface is rendered glossy by means of a grinding wheel with a grit size from 20 to 50 and preferably from 30 to 40, and then finished with a diamond grinder with a grit size from 50 to 90 and preferably 60 to 80.

Advantageously, said base is an epoxy quartz base, which ensures the aggregate adheres to the slab or panel, guaranteeing its durability.

Advantageously, said base coat is replaced by a different adhesive or acrylic primer compatible with said slab or panel to ensure they stay firmly in place.

Advantageously, colour pigments are added to the aggregate in a percentage of from 0.5 to 4% and preferably from 1 to 2.5%, to impart a desired coloration.

Advantageously, said diamond grinding wheel used for polishing the exposed surface is a diamond grinding wheel that heats the surface up locally and filling any pores to make the surface waterproof.

Advantageously the polished surface is rendered glossy with further polishing with a diamond grinding wheel with a grit size from 90 to 4000 and preferably from 100 to 400.

Advantageously, said panels are shaped according to the installation needs and simply rest on screed or on the previously prepared base, or on walls or ceilings, with considerable benefits in terms of construction work.

Advantageously, said panels are applied to vertical walls or on the ceiling, since the product has already been cured before they are applied and fixed, mechanically or with adhesives, in such vertical or ceiling installation conditions.

Advantageously, said panels are particularly suitable for a floor heating system or a wall or floor cooling system, especially with honeycomb aluminium slabs, or with calcium-silicate slabs, being able to distribute the heat of the underlying heating tubes evenly on the surface.

The method of making the artefact just described involves the following steps, consisting of:
Position the panel or slab horizontally;
Apply the primer on a larger surface of said panel or slab;
Dry mix the components with marble or stone powders, with lime, with cement;
Possible addition of pigments or oxides or earths to the components to be mixed;
Add water with the dispersion of vinyl or acrylic resin to the mix until an even paste of the aggregate is obtained
Spread said homogeneous aggregate paste on said panel to which said primer has been previously applied;
Cure the homogeneous paste to reach the required thickness slightly greater than the finished thickness;
Cure the untreated product from 12 to 48 hours and preferably from 24 to 36 hours;
Dry grind with a metal diamond brush grinder or ceramic diamond brushes, with a grit size from 20 to 50 and preferably from 30 to 40, until the protruding pieces are chamfered beyond the thickness provided by the homogeneous paste;
Dry grinding with a metal diamond brush grinder or ceramic diamond brushes with grit sizes from 50 to 90 and preferably from 60 and 80;
Creation of a grout with the powder resulting from the roughing and/or polishing phase mixed with water added with vinyl or acrylic resin;
Grouting with the grout, previously prepared, and then grinding with resinoid brushes with a grit size of 100-200 until reaching the desired gloss and preferably from 30 to 80 gloss and even more preferably from 40 to 60 GU gloss (measured according to ISO2813/ASTM D523).

Advantageously, with the grouting and/or grinding with ceramic diamond brushes and/or resinoids in the presence of a grout, the increased heating of the surface being treated and the closing of the pores of the exposed surface of the product make it impermeable.

Advantageously, with the aforementioned method of manufacturing the product, it is possible to prepare the flooring away from the actual installation site, with control of the preparation, curing, and finishing conditions of the product, and/or under any external weather conditions.

### BRIEF DESCRIPTION OF THE DRAWINGS

The technical characteristics of the invention, according to the aforesaid objects, can clearly be seen in the claims below, and its advantages will become more readily apparent in the detailed description that follows, made with reference to the accompanying drawings, which illustrate a preferred embodiment, which is purely exemplary and not limiting, in which:

FIG. 1 shows a sectional view of the stratification within the artefact.

FIGS. 2-6 show a schematic representation of the main steps of the process for making the artefact, in particular with: the spreading of the primer on the panel; the spreading of said homogeneous paste on said panel; rough cutting; polishing.

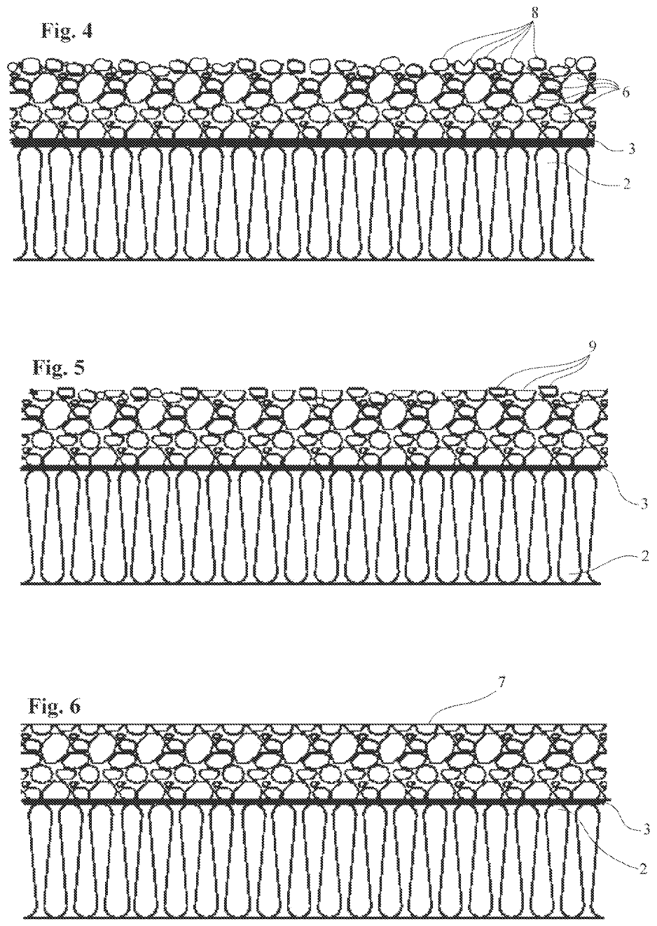

### DETAILED DESCRIPTION OF AN EXEMPLARY PREFERRED EMBODIMENT

With reference to the drawings, it is possible to examine the lightweight and thin Venetian-style floor (hereinafter also only:
artefact) and the related construction process.

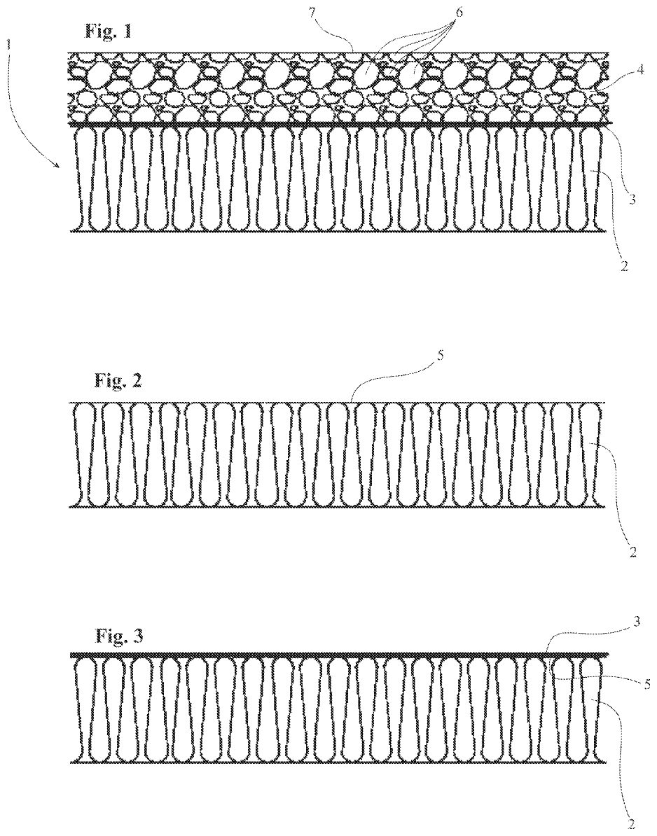

In FIG. 1 it is possible to observe the stratification of the artefact that includes a panel, lightweight and thin, on whose largest surface 5 there is an undercoat or primer 3 above which is the aggregate 4.

The exposed surface 7 of the aggregate 4 is made flat with grinding and polishing leaving the pieces 6 of the various materials exposed, generally stones, or other stone and inert materials, but also possibly replaced by organic inert material.

The defining feature of this artefact is that it is a Venetian-style floor, with all the advantages of the characteristics of such flooring, without the main defects or drawbacks, such as the weight, thickness, the difficulties of construction in situ, and the possibility of installing on vertical walls or ceilings.

The panels, which can be of various types, all with pre-defined dimensions, lightweight and thin, can be joined side by side to create a single larger panel, with the only limit dictated by the ease of transport for the admissible dimensions, for example, by road.

Said panels can also be of the sandwich variety or an alveolar or a honeycomb slab, which have a considerable load-bearing capacity with a smaller thickness and lower weight, also allowing a slight flexion to be able to adapt to any installation requirements.

The base coat or primer laid by spray or brush or roller on the largest surface of one of the aforementioned slabs or panels, makes sure that aggregate adheres to the panel, preventing detachments or cracking of the aggregate above the panel.

If necessary, said base coat or primer can be present on the surface of the slab or panel already in the production phase of the slab or panel itself.

The main characteristic of the composition of the aggregate are the pieces of stones or other stony material or inert material, but it is also possible to use an organic inert, retained by a binding substance made of lime and cement.

Any additions of oxides, fibres, resins, etc. increase or modify the physical performance of the binding substance by conferring a desired coloration or by increasing flexibility or increasing the thermal transmittance.

Said pieces remain protruding beyond the height of the finished floor in an irregular manner and are therefore brought to the level of the finished floor by means of mechanical grinding or polishing.

The aggregate stands out from the binding substance on the exposed surface after appropriate roughing, sanding and/or polishing.

This surface is also completely smooth or glossy, continuous and waterproof thanks to the closure of the surface pores, ensuring that the Venetian-style floor, which is the object of the invention, is kept unaltered.

The process for obtaining the artefact of the invention consists of the following phases:
the support panel or slab is laid horizontally on of one of its main surfaces; the primer or base coat is applied to aid surface to ensure the aggregate adheres to the panel;
the mixture of aggregates and slices is prepared dry, with marble or stone powders, lime, cement, possibly combining oxides, or pigments, for the necessary coloration of the binder, any fibers or other resins, soluble or not, are combined to confer better flexibility and/or elasticity to the finished product, cocciopesto is also added to increase the finished product's resistance characteristics;
everything is mixed with water containing vinyl resins and/or acrylic resins until a homogeneous paste of the aggregate is obtained;
as long as said primer or base coat is still fresh, and has not dried, said homogeneous paste of the aggregate is spread on said panel to which said primer has been previously applied.

There is therefore a curing phase of the homogeneous paste to reach a thickness of 1.1 to 2 times the expected thickness of the finished floor, leaving exposed on the surface the pieces to be highlighted in view on the exposed surface of the finished floor.

The untreated artefact is then allowed to cure from 12 to 48 hours and preferably from 24 to 36 hours, so as to allow the aggregate to reach a solid consistency for the subsequent phases.

Subsequently, the roughing and dry polishing phases are carried out using diamond, metal or ceramic brushes win an appropriate grain size, with dust extraction.

The resulting powder from the polishing and/or roughing is then made into a grout with water containing vinyl or acrylic resin.

This grout is used for grouting the gaps and closing the pores.

The closure of the pores is also carried out with the use of polishing with resinoid brushes that, through a local overheating of the treated surface, makes the polished surface impermeable.

Depending on the grain of the brushes used, the desired shine is finally achieved for the visual appearance of the surface finish.

It is noted that the artefact made with the above-mentioned process achieves the intended purposes, obtaining in fact an artefact prepared, also away from the installation site, with control of the preparation, maturing and finishing conditions of the product, and/or with any external weather condition.

1. Venetian-style flooring using thin and lightweight slabs characterised by the fact that it comprises at least one slab (2) or support panel, preferably an alveolar or honeycomb slab, with a thickness of 0.5 to 4 cm and preferably 1.0 to 2.0 cm, with a weight of 0.5 to 12 kg/sq. m, a base coat (3) or primer, applied directly on said slab (2) or said panel, with a thickness of 0.1 to 6 mm and preferably 0.2 to 2 mm, a conglomerate (4), placed directly on said primer (3), with a thickness of 0.2 to 4 cm and preferably of 0.5 to 2.5 cm, comprising:
Pieces of stones (6), or another stony material to be exposed on the visible surface, such as: aggregates or organic materials, or, in particular, cocciopesto, and marble or stone powders from 30 to 60% by volume and preferably from 40 to 55% of the dry aggregate, with the maximum size being no greater than 1.5 times the thickness of the aggregate (4) with respect to the finished floor height;
cement from 5 to 20% by volume of the total dry conglomerate;
lime from 10 to 60% by volume of the total dry conglomerate;
eventual water-soluble powder resin from 0.5 to 4% by volume of the total dry conglomerate (4);
eventual reinforcing fibres for cement of steel or based on polypropylene or synthetic fibres from 0.1 to 8% by volume of the total dry aggregate;
water with a dispersion of vinyl or acrylic resin, sufficient to mix the aggregate (4);
where the visible surface (7) of said aggregate (4) has been dry sanded with a diamond grinding wheel, in several passes, to be make it flat and shiny, removed of the protruding parts of any pieces (6) and marble powders.

2. Venetian-style flooring using thin and lightweight slabs according to claim 1, characterised by the fact that said visible surface (7) is given a shine by means of a roughing wheel with a grit size of 20 to 50 and preferably 30 to 40, with a diamond finishing wheel with a grit size of 50 to 90 and preferably 60 and 80.

3. Venetian-style flooring using thin and lightweight slabs according to claim 1, characterised by the fact that said base coat (3) is a quartz epoxy base coat that ensures that the aggregate (4) adheres to the slab (2) or to the panel, and ensuring that the hold is durable.

4. Venetian-style flooring using thin and lightweight slabs according to claim 1, characterised by the fact that said base coat (3) is replaced by a different acrylic glue or primer compatible with said slab (2) or panel to provide the adhesion.

5. Venetian-style flooring using thin and lightweight slabs according to claim 1, characterised by the fact that colouring pigments in a percentage of 0.5 to 4% and preferably of 1 to 2.5% are added to the aggregate (4) to give it the desired colour.

6. Venetian-style flooring using thin and lightweight slabs according to claim 1, characterised by the fact that said diamond wheel for grinding the visible surface (7) is a diamond wheel that heats the surface locally and grouts any pores to make the surface waterproof.

7. Venetian-style flooring using thin and lightweight slabs according to claim 1, characterised by the fact that the polished surface is made shiny by means of additional polishing with a diamond wheel with a grit size of 90 to 4000 and preferably 100 to 400.

8. Venetian-style flooring using thin and lightweight slabs according to claim 1, characterised by the fact that said panels (2) are shaped according to installation requirements and are simply rested on screed or on a previously prepared base, or on walls or ceilings, providing considerable advantages for carrying out the building work.

9. Venetian-style flooring using thin and lightweight slabs according to claim 1, characterised by the fact that said panels are applied on vertical walls or on the ceiling, where the artefact has already been cured before application and fixing, either using mechanical devices or adhesives, in these conditions of installing in the vertical or on the ceiling.

10. Method for making Venetian-style flooring using thin and lightweight slabs according the following steps, consisting of:
Positioning the panel (2) or slab horizontally;
Applying the base coat (3) or primer on a larger surface (5) of said panel (2) or slab;
Dry mixing the components of the pieces of stone (6) with marble or stone powders, with lime, with cement;
Possible addition of pigments or oxides or earth to the components to be mixed;
Adding water with vinyl or acrylic resin to the mix until a homogeneous paste of the aggregate (4) is obtained;
Applying said homogeneous paste to the aggregate (4) on said panel (2) to which said base coat (3) or primer has been previously applied;
Levelling of the homogeneous paste to reach the expected thickness, slightly greater than the finished thickness of the floor;
Curing of the untreated artefact from 12 to 48 hours and preferably from 24 to 36 hours;
Dry roughing with a grinder with metal diamond brushes or ceramic diamond brushes, with grit sizes from 20 to 50 and preferably from 30 to 40, until the pieces (6) protruding from the homogeneous paste are smoothed out;
Dry sanding with a sander with metal diamond brushes or ceramic diamond brushes with grit sizes from 50 to 90 and preferably from 60 and 80;
Creation of a grout with the powder resulting from the roughing and/or polishing phase mixed with water and added vinyl or acrylic resin;
Grouting with the grout, which is prepared beforehand, and then resin sanding with brushes with a grit size of 100-200 until reaching the desired gloss and preferably from 30 to 80 gloss and even more preferably 40 to 60 GU gloss (measured according to ISO 2813/ASTM D523).

11. Method for making Venetian-style flooring using thin and lightweight slabs according to the claim 10 with the permanence of the grouting and/or sanding with the ceramic and/or resin diamond brushes in the presence of grout to heat the treated surface and close the pores of the visible surface of the artefact, rendering it waterproof.
